(19) United States
(12) Patent Application Publication
(10) Pub. No.: US 2018/0349433 A1
(43) Pub. Date: Dec. 6, 2018

(54) AGNOSTIC DATA FRAME FOR DATA BACKEND

(71) Applicant: General Electric Company, Schenectady, NY (US)

(72) Inventors: Paul BAINES, El Cerrito, CA (US); Ratish DALVI, San Ramon, CA (US)

(21) Appl. No.: 15/992,570

(22) Filed: May 30, 2018

Related U.S. Application Data
(60) Provisional application No. 62/512,591, filed on May 30, 2017.

(51) Int. Cl. G06F 17/30; G06F 9/54

(52) U.S. Cl. CPC G06F 17/30371; G06F 15/18; G06F 17/30424; G06F 9/54

(57) ABSTRACT

The example embodiments are directed to a system and method for generating an agnostic data frame for a plurality of different backend storage systems. In one example, the method includes loading data from a data storage that has a data structure format from among any of a plurality of different data structure formats, converting the loaded data into a data-structure-agnostic data object, executing a processing request on the data-structure-agnostic data object to generate a processing response based on the converted data, and transmitting information about the generated processing response to one or more of an application and a system associated with the processing request.

### CROSS-REFERENCE TO RELATED APPLICATION(S)

This application claims the benefit under 35 USC § 119(e) of U.S. Provisional Patent Application No. 62/512,591, filed on May 30, 2017, in the United States Patent and Trademark Office, the entire disclosure of which is incorporated herein for all purposes.

### BACKGROUND

Machine and equipment assets are engineered to perform particular tasks as part of a process. For example, assets can include, among other things and without limitation, industrial manufacturing equipment on a production line, drilling equipment for use in mining operations, wind turbines that generate electricity on a wind farm, transportation vehicles, gas and oil refining equipment, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software. For example, analytic applications are being used to visualize and enhance operations of machine and equipment assets using data captured from an asset. Analytics can provide some form of understanding of the data to a user.

Data from machine and equipment assets may be monitored and analyzed using software applications (e.g., analytics) that rely on machine learning. In order to consume the data, the data is typically stored in a backend data storage system such as a database, a file system, a cloud platform, or the like. At present there are numerous different backend storage systems available. Different types of backend storage systems may provide benefits over the other backend storage systems depending on a use case for the data. The benefits provided by each backend are typically a result of a data structure format used by the backend system to store the data.

However, when a software developer designs an application that must interact with more than storage backend, the developer often develops conditional code using “if” and “else” statements in order to enable the software to adapt to the specific storage backend from among a plurality of possible storage backends, and to interact with the backend system accordingly. As a result, a significant amount of additional code is needed to interact with multiple storage backends. Furthermore, when a new storage backend (or an updated storage backend) is made available, the developer is required to make wholesale code changes to the software application to make the application compatible with the new or updated storage backend.

### SUMMARY

The example embodiments improve upon the prior art by providing an agnostic data frame interface. A data structure (e.g., data frame, data array, list, etc.) is a columnar representation of data that is commonly used or otherwise consumed by machine learning systems (e.g., a data frame could be an output of a database query). A backend system typically has its own data structure format for storing data. For a software program to interact with multiple data backends, the software code typically requires separate commands and functions for interacting with each. The example embodiments overcome this by implementing a data frame agnostic application programming interface (API) that handles data interaction between a software application and any of a plurality of different backend systems. Data from a backend system can be ingested by the API and converted into a format-agnostic data object (also referred to herein as a data-frame-agnostic data object). The application then interacts with data included in the format-agnostic data object instead of interacting directly with the backend system. Through the API, the application is able to interact with data from different storage backends using a single API.

When the software application triggers a change to the data via interaction with the data-frame-agnostic data object, the API can communicate with the data backend and trigger a corresponding change to the data as it is stored in the backend. The API creates a layer of abstraction between a data frame structure in which data is stored “under the hood” and a software application interacting with and manipulating the data. As a result, the API creates a unified communication interface for interacting with data stored in a plurality of different data structures. Accordingly, a developer does not need conditional language for addressing different types of data structure formats but only needs a single set of instructions. Furthermore, the application can be scaled with ease to include a new or updated backend storage structure format by a simple change in the API.

According to an aspect of an example embodiment, a computing system includes a memory, and a processor configured to load data from the memory which has a data structure format from among any of a plurality of different data structure formats, convert the loaded data into a data-structure-agnostic data object, execute a processing request on the data-structure-agnostic data object to generate a processing response based on the converted data, and transmit information about the generated processing response to one or more of an application and a system associated with the processing request.

According to an aspect of another example embodiment, a computer-implemented method includes loading data from a data storage that has a data structure format from among any of a plurality of different data structure formats, converting the loaded data into a data-structure-agnostic data object, executing a processing request on the data-structure-agnostic data object to generate a processing response based on the converted data, and transmitting information about the generated processing response to one or more of an application and a system associated with the processing request.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment in accordance with an example embodiment.

FIG. 2 is a diagram illustrating a process for interacting with different backend systems in accordance with an example embodiment.

FIGS. 3A and 3B are diagrams illustrating formats of different data structures in accordance with example embodiments.

FIG. 4 is a diagram illustrating a data-structure-agnostic data object in accordance with an example embodiment.

FIG. 5 is a diagram illustrating a method for implementing an agnostic data structure in accordance with an example embodiment.

FIG. 6 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Data backend storage systems (e.g., databases, file servers, cloud platforms, etc.) store data on a large-scale. A data backend does not typically include end-user applications running therein. Instead, the data is made accessible to users indirectly or through low level manipulation of the data such as Structured Query Language (SQL) commands, and the like. The data backend may implement different data structure formats for internally storing the data. Examples of data structures include NumPy arrays, Pandas data frames, Spark data frames, Wise data frames, lists, and the like. While there are many different implementations of data structures, specific representations may perform better in some workflows and poorly in others. For example, Pandas data frames have an internal structure that is better suited for storing columnar-based data such as data that is used with random forest machine learning algorithms. Meanwhile, Spark data frames have an internal structure that is better suited for storing row-based data. When interacting with different storages systems, a software developer is often required to generate code differently for each backend system to address unique backend APIs, primitives, operations, and the like, which are associated with each backend.

According to various aspects, provided is a flexible data frame representation that abstracts away the specific implementation of the underlying data structure of a data backend and focuses on the operations performed by software applications and other systems interacting with the data. The data frame representation is implemented via a data frame agnostic API through a software library. The API may be inherently leaner than the backend API's of any of the individual backend data frame representations. Furthermore, the abstract data frame representation may also retain the ability to convert to a specified “native” representation of any of the implemented data backends when a more esoteric operation is to be performed. By abstracting in this way, data frames can be easier to hold in memory and manipulate than previously possible, and the manipulation can be performed without having to know the specifics of individual data frame backbends. Furthermore, platforms can assist with indexing on data frames, and can achieve performance gains over previous data frame implementations.

The data abstraction may be performed by the API described herein which is realized through a software library according to various embodiments. The software library can be incorporated by developers and may be used to interact with data stored in different data backends. During abstraction, the API may ingest or otherwise load data having any of a multiple of different data structures into a data object that is data-structure-agnostic. The data may be pulled-in from any of a number of different data backend formats and converted into the data-structure agnostic data object thereby providing a unified representation of the data regardless of the data backend “under the hood.” Once ingested, a variety of functions and operations may be processed on the data to interact and manipulate the data without the application software needing to interact directly with the underlying backend system or data structure.

During operation, a copy of the data may remain stored in the backend system, and the API may coordinate the operations performed on the data across the backend systems. For example, when an application performs an operation on a column of data included in the data-structure agnostic data object, the API may specify how the function should be delegated to the specific data backend where the data is stored. Here, the API may automatically communicate with the data backend based on primitives, operations, APIs, and the like, unique to the data backend. Furthermore, the API can be extended to implement new and updated data backend data structures by adding (or implementing) primitives and operations of the new or updated backend to the API. Accordingly, the API can be scaled without requiring a software application to change code.

The system described herein may be incorporated within or otherwise used in conjunction with applications for managing machine and equipment assets and can be hosted within an Industrial Internet of Things (IIoT). For example, an IIoT may connect manufacturing plants and assets, such as turbines, jet engines, locomotives, elevators, healthcare devices, mining equipment, oil and gas refineries, and the like, to the Internet, the cloud, and/or to each other in some meaningful way such as through one or more networks. The system described herein can be implemented within a “cloud” or remote or distributed computing resource which includes clustered computing resources capable of efficiently deploying many ML models. The cloud can be used to receive, relay, transmit, store, analyze, or otherwise process information for or about assets and manufacturing sites. The cloud computing system can further include or can be coupled with one or more other processor circuits or modules configured to perform a specific task, such as to perform tasks related to asset maintenance, analytics, data storage, security, or some other function.

Integration of machine and equipment assets with the remote computing resources to enable the IIoT often presents technical challenges that are separate and distinct from the specific industry and from computer networks, generally. An asset (e.g., machine or equipment) may need to be configured with novel interfaces and communication protocols to send and receive data to and from distributed computing resources. Also, assets may have strict requirements for cost, weight, security, performance, signal interference, and the like. As a result, enabling such an integration is rarely as simple as combining the asset with a general-purpose computing system.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial and/or healthcare based assets can be uniquely situated to leverage its understanding of assets themselves, models of such assets, and industrial operations or applications of such assets, to create new value for industrial customers through asset insights.

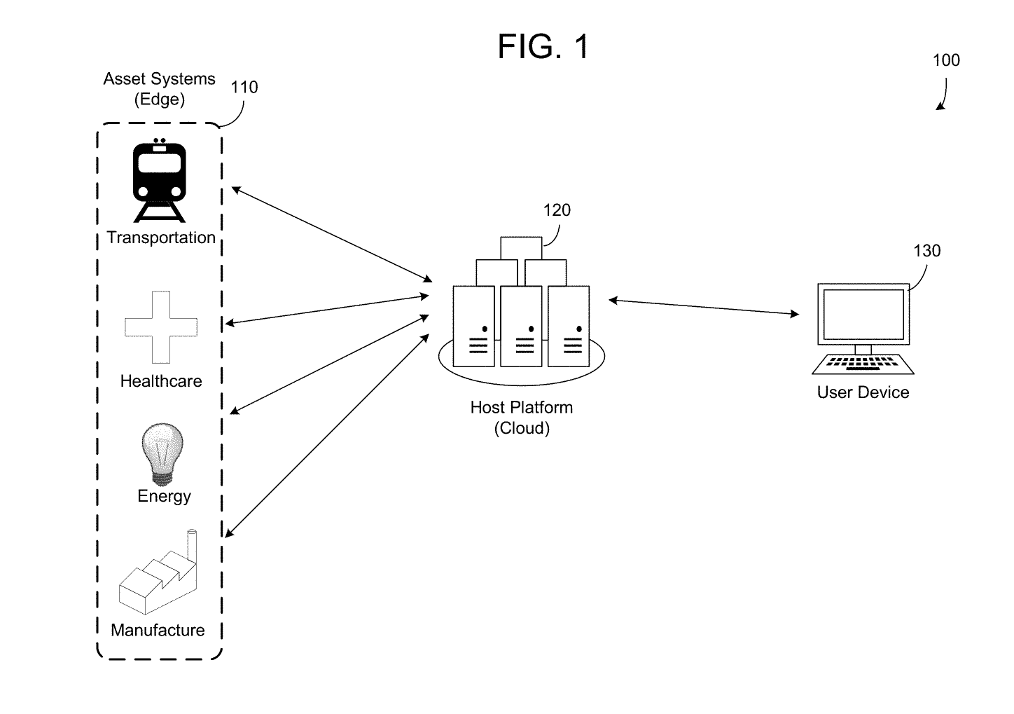

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, a database, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like.

The data transmitted by the assets 110 and received by the cloud platform 120 may include raw time-series data, alert information, images, and the like, which are output as a result of the operation of the assets 110. Data that is stored and processed by the cloud platform 120 may be monitored and output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets) may be hosted by the cloud platform 120 and may interact with the asset. For example, analytic applications implementing one or more machine learning (ML) models may be used to optimize a performance of an asset or data coming in from the asset. As another example, the ML models may be used to analyze, control, manage, repair, or otherwise interact with the asset and components (software and hardware) thereof. The user device 130 may receive views of data or other information about the asset as the data is processed via one or more analytic applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110.

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110. The data storage backend described herein may be included within or coupled to the cloud platform 120.

In some examples, the cloud platform 120 may host an industrial application marketplace where developers can publish their distinctly developed applications and ML models and/or retrieve applications and ML models from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

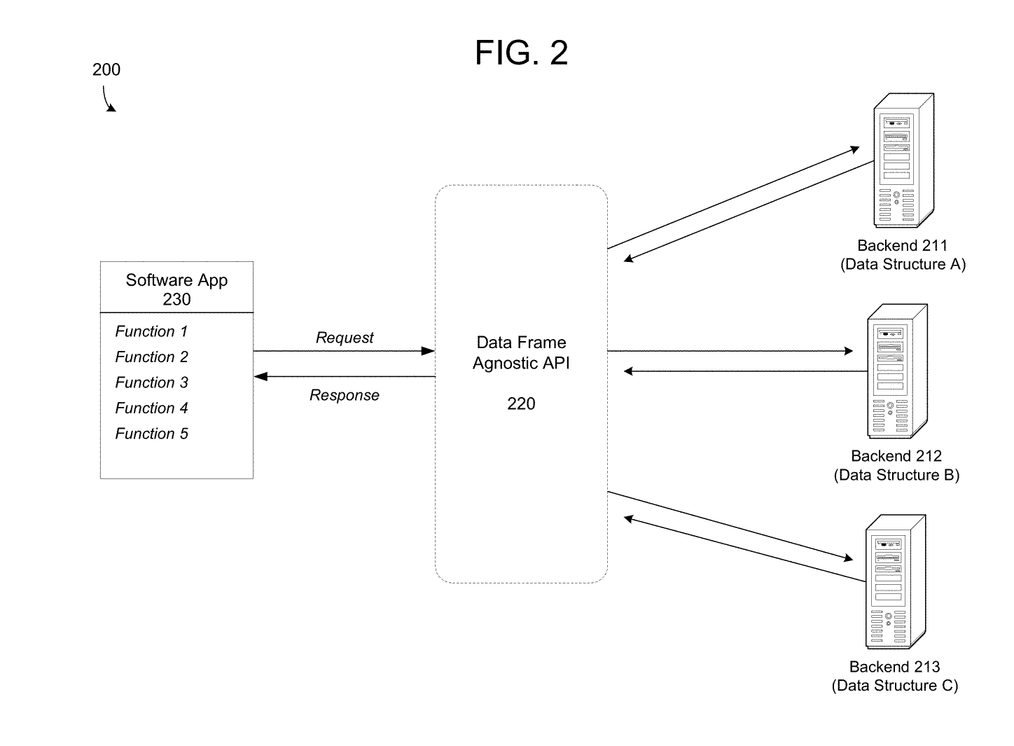

FIG. 2 illustrates a process 200 for interacting with different data backend systems in accordance with an example embodiment. Referring to FIG. 2, a plurality of different data backend systems 211, 212, and 213 are shown. Each data backend 211, 212, and 213 may have its own data structure format for storing data therein. Also shown is a software application 230 that interacts with data stored in the data backends 211, 212, and 213. In this example, the process 200 is performed by a data frame agnostic API 220 that generates a data object that is agnostic with respect to how the data is stored within the different backends 211, 212, and 213, and that allows the software application 230 to seamlessly interact with data stored therein. In operation, the application 230 may request a data block from the API 220. Here, the API 220 may receive the request based on a command defined by the software library according to various embodiments. The software library provides a number of different operations and functions that can be performed via the API 220. In response to receiving the request, the API 220 may ingest or otherwise pull-in data from a corresponding data backend, convert the data into an agnostic data structure, and perform functions and/or operations on the data.

As described herein, the data backends 211, 212, and 213 represent formats for storing data. A common Python format for storing data in a data backend is NumPy arrays. Other examples of data structure formats include Pandas data frames, Spark data frames, Wise data frames, lists, and the like. The data stored in the data backends 211, 212, and 213 may be industrial data fed from an asset or another edge system. Here, a developer may desire to build an application around the industrial data. In this example, the developer may interact with the software library by providing information identifying the data to be ingested, a schema of the data, and the like, and the API 220 may ingest the data from any of the data backends 211, 212, and 213, into a data object which is agnostic to how the data is stored in the data backends 211, 212, and 213. The data object supports standard operations that can be performed regardless of how the data is stored in the backend.

For example, the developer may specify the data (columns, rows, etc.) and the API 220 may create a new data object and ingest data into the data object. Once the data is ingested, standard operations that the API 220 supports may be performed. In this case, when the data within the data object is manipulated by the software 230, the API 220 can coordinate the change to the data as it is stored in the corresponding backend regardless of which specific data backend stores the data. The API 220 coordinates the ways that the different data backends 211, 212, and 213 store and manipulate the data based on interaction of the software application 230 with the data object. The API 220 may implement operations across the different backend systems 211, 212, and 213, based on primitives, operations, APIs, and the like, which are defined in advance for the respective backend systems and stored in the API 220. In contrast, related data storage systems require separate libraries and separate calls to store and manipulate data in each individual backend.

According to various aspects, the API 220 provides a unified layer of abstraction that allows the software application 230 to interface with data from the different backend systems 211, 212, and 213, via a common library having common operations and functions. Furthermore, program code of the software application 230 may be scaled to include a new data backend (by scaling the API 220 to include the additional backend implementation) without requiring the developer of the software application 230 to add to or change existing code. Instead, the code of the software application 230 can remain the same or a small change can be made to specify the backend being used as the new backend. The backend implementation within the API 220 configures a communication process between the API 220 and the backend primitives and operations which becomes part of the library.

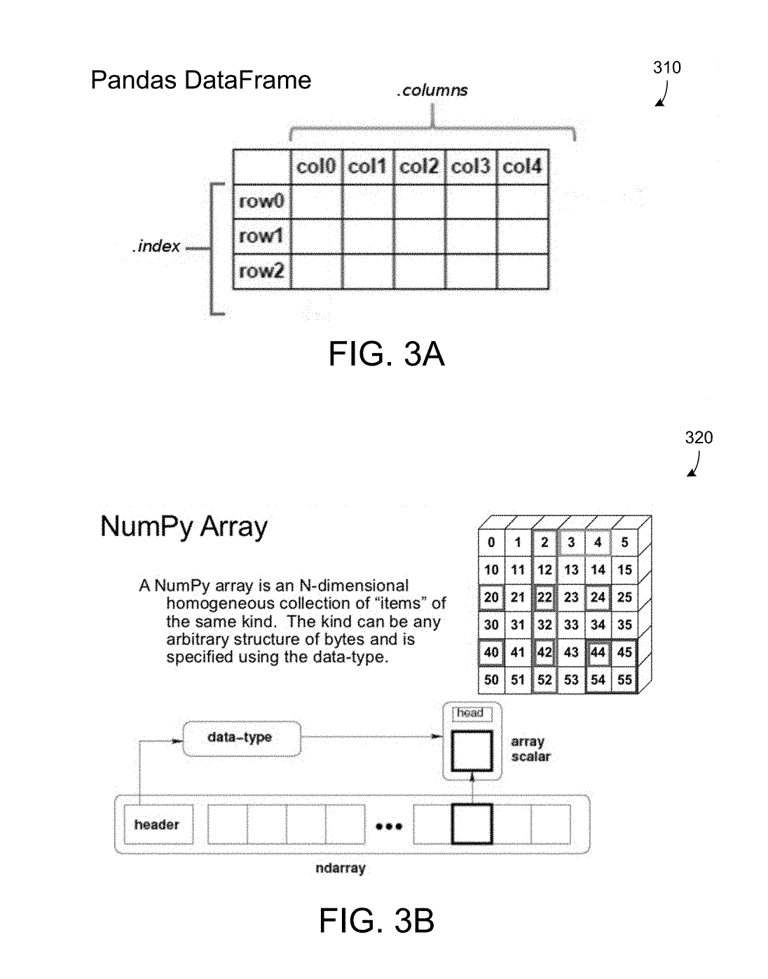

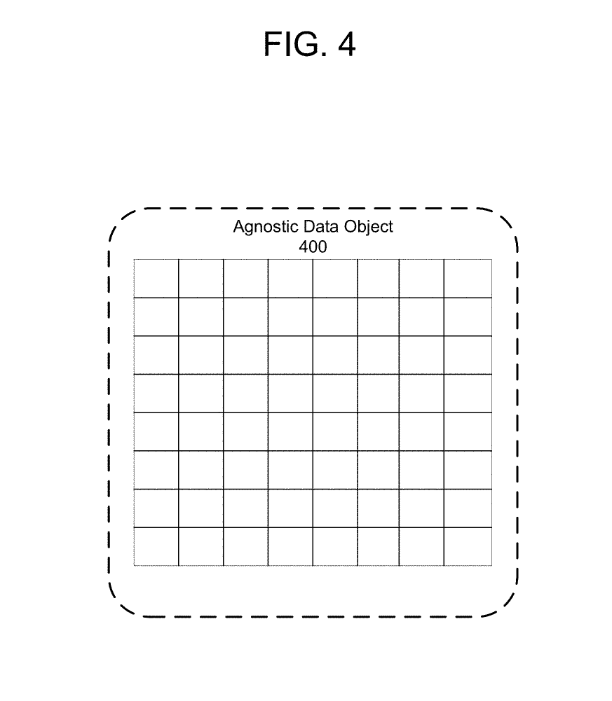

FIGS. 3A and 3B illustrate formats of different data structures in accordance with example embodiments, and FIG. 4 illustrates a non-limiting example of a data-structure-agnostic data object in accordance with an example embodiment. While there are many specific implementations of data structures, FIG. 3A illustrates an example of a Pandas data frames 310 and FIG. 3B illustrates an example of a NumPy array 320. It should be appreciated that these and other specific representations not shown may perform well in some workflows and poorly in others. Both the Pandas data frame 310 and the NumPy array 320 are data structures of frames in a backend Python programming language. However, embodiments are not limited to Python-based backends. As another example, the data backend may have a data structure such as a Spark data frame, a Wise data frame, a list, and the like.

Meanwhile, FIG. 4 illustrates a flexible data frame representation 400 that is data-structure agnostic. The agnostic data frame 400 may abstract away the specific implementation and focuses on the operations performed by software and systems. The agnostic data frame 400 may inherently have a leaner API than the API's of the Pandas backend and the NumPy backend. Furthermore, the API that implements the agnostic data frame 400 may also retain the ability to convert the data ingested within the agnostic data frame 400 to a specified “native” representation (e.g., Pandas data frame 310, NumPy array 320, Spark data frame, Wise data frame, TensorFlow, list, etc.) when a more esoteric operation is needed.

According to various embodiments, the agnostic data frame 400 abstraction is provided to a developer (or a developed software application) via a high-level API that describes how to interact with the agnostic data frame 400. The API includes the ability to perform a set of well-defined operations, such as subsetting, mathematical operations like .sum( ) and .mean( ) and data manipulation tasks such as .groupby( ). The abstraction via the data frame agnostic API obviates the need to be tied to any single data representation under the hood, and the data frame abstraction can support a plurality of “data backends.” A data frame backend may be a specific implementation of a data frame or an array that can perform some or all standard data frame operations.

The agnostic data frame 400 according to various embodiments can provide various benefits over the backend-specific data structures. For example, the agnostic data frame 400 may provide flexibility to handle both data frame-based and array-based workflows, provide an interface with existing third-party or open source machine learning (ML) tools, such as TensorFlow, Spark, etc., provide a data frame representation independent of any specific implementation, provide sufficient performance with respect to terms of memory usage and speed, and the like. Furthermore, the API which implements the agnostic data frame 400 may coordinate data manipulation within the respective data backends based on data interaction of data ingested by the agnostic data frame 400.

The Pandas data frame 310 and the NumPy array 320 provide ways to store data and perform standard data science and ML operations but are more suitable for specific applications and not others. For instance, the NumPy array 320 may be well-suited for image-based ML applications, such as facial recognition or objection detection using deep learning. Meanwhile, the Pandas data frame 310 may be more suitable for time series data applications that need more flexible and expressive indexing. The agnostic data frame 400 may be used to abstract away the different internal structures of the Pandas data frame 310 and the NumPy array 320.

In addition to abstracting away the different data structures, the API described herein may receive data for storing and determine an optimal backend for storing the data. In this example, the API described herein may utilize a plurality of data frame backends and intelligently select a data backend based on a use case of the data and an internal structure of the data frame associated with the data backend. The data frame system can also include commonalities in operations performed by different data structures in the ML applications and, as such, can be beneficial in data science and various ML applications.

Through data frame abstraction, the API shields a user from exposure to a set of data frame backend, thereby permitting new backends (e.g., that perform well in specific settings) to be added without breaking existing applications that utilize the data frame API. The system may provide a user-facing API that is stable, so new versions of specific data frame backends can be carefully managed and upgraded when appropriate. Using data abstraction, the system can permit a program to seamlessly adapt to different data workflows (e.g., time series and images) using the same API. The system can provide interfacing to a third-party tool that depends on specific data frame formats. In some embodiments, the API makes no assumptions about where the data lives (e.g., whether it is in memory, out-of-core, or in distributed storage). Where a specific function or third party tool uses a primitive that is not available in the API, the API can provide conversion methods that can convert data be available in a specific format (e.g., specific native data types). For instance, the API can support one or more of the following native data structures.

According to various aspects, and as a non-limiting example, data can be respectively coerced from one of the specific data structure formats by the following API methods: to_pandas( ); .to_numpy( ); and .to_dataset( ). If, for instance, the data is already stored as a pandas.DataFrame under the hood, then .to_pandas( ) can be a no-op that passes a reference to the data. A conversion method provided by the API may be lossless or lossy (e.g., in the least nondestructive manner as possible). For example, a WiseML.DataSet may comprise a single data type for each column, whereas a pandas.DataFrame column (i.e., a Series) may comprise multiple data types.

The API described herein can also include additional methods for use with the agnostic data frame object 400 such as the following:
Data.loc[idx]: provides index-based row subsetting of a data frame object. idx can be any sequence (e.g., a list, numpy.array or slice). This row-based subsetting may return another data frame object.
Data[col] or Data.get_column(col): provides column-based access of a data frame object. col may be a single, or a list of columns. If a list, then a data frame object is returned, otherwise a column object may be returned.
Data.save(filename, **pars): saves a data frame object to file,
Data.load(filename, **pars): loads a data frame object from file,
Data.add_column(data, col_name): adds a column to a data frame object,
Data.delete_column(col_name): deletes a column from a data frame object.
Data.apply(func, axis): applies an arbitrary function along an axis of a data frame object.
Data.sort_values(by, ascending=True): sorts the row-ordering of a data frame object based on the values of the ‘by column.
Data.to_[native]( ): converts the data frame object into a native data representation. For example, Data.to_pandas( ) will convert the data frame object into a pandas.DataFrame.

According to some embodiments, slicing a data frame object into a specific column returns a column object may include the following methods:
Column.loc[idx]: provides index-based subsetting of a column object.
Column.sum( ): sums across all entries of a column.
Column.max( ): computes the maximum value in the column.
Column.min( ) computes the minimum value in the column.
Column.value_counts( ): computes the number of occurrences of each unique value in the column.
Column.isnull( ): returns a boolean column object indicating which entries of the column contain “null” or “missing” values.
Column.apply(func): applies an arbitrary function over the column.
Column.to_[native]: converts a column object into a native column data representation. For example, column.to_pandas( ) may convert to a pandas.Series.

With respect to data column types, some embodiments support one or more of column types that are numeric, text-based, arrays, datetime, and the like.

The API can provide a primitive.min( ) method for one or more of numeric, datetime columns, text, or array columns (e.g., could be implemented for those columns if an appropriate definition is chosen). Each column of a data frame object may have an associated column type and the implementation details can be abstracted away for high-level data science code. For example, for a data frame object including a datetime column, the API can interact with the datetime column and does not need to know anything about the implementation details, but can ensure that primitives (e.g., .min( ) or operators such as >=) are available. The data for the datetime column may, for example, be stored using Pandas datetime structures, NumPy datetimes, or even WiseML datetimes. If a new, better implementation of datetime comes available, code (e.g., application code) would not need to change if it uses a method, of an API of an embodiment, defined on the column type class. In some embodiments, the choice of column types includes: a general column types, such as numeric, text, categorical (e.g., as used in WiseML); a column type having more specificity (e.g., integer, decimal, short text, and long text). Some embodiments implement data type backends that map data types into core image column types.

According to some embodiments, the API provides dynamic data frame backend selection. In particular, the API can dynamically select, from a set of available data frame backends, a data frame backend that is suited for a particular task. The API may implement dynamic data frame backend selection by deferred execution of data frame operations. The data frame system can implement lazy evaluation, where the result of a function is not immediately evaluated but, rather, evaluated when explicitly needed. Lazy evaluation permits various embodiments to construct a task graph that describes all of the computational that must be performed (e.g., based on function calls made through the API of an embodiment). After its construction, the task graph can be optimized to ensure that the evaluations (e.g., calculations) are performed in an optimal order. For instance, task.delayed can be utilized to produce an optimized computation graph for Python operations.

The API may combine lazy evaluation with a backend-agnostic data frame representation to enable construction of a set of intelligent data pipelines, each of which may: (i) determine what types of computation need to be performed; (ii) identify where a specific native data type is needed; and (iii) select an optimal data frame backend to use at a given point of the computation. In this way, a computational graphs can be used with a backend-agnostic data representation to optimize for a data-flow property, such as memory usage or I/O. This can also ensure that data pipelines can use an optimal data representation for each part of a complex workflow.

The following illustrates an example workflow utilizing an API of an embodiment with respect to a Data object type, which represents a data frame object type.

import Data

# Load data from a csv into a Data data frame object:

d=Data.load_csv(“data.csv”, columns=[“a”, “b”, “y”])

# Add a new column:

d[“X”]=d[“a”]+d[“b”]

# Convert to a numpy array and train a model:

m=train_model(d[“X”].to_numpy( ), d[“y”].to_numpy( ))

In this example, Data.load_csv( ) returns a future, that is, defers reading the data from the file. Similarly, when a new column is added to the d Data object, the computation remains deferred. In the final line, where the columns are explicitly converted to a numpy.ndarray, the previous steps in the computation are performed. In this example, there may be a plurality of data frame backends that support reading from csv files (e.g., both pandas and numpy), so the Data object may have flexibility in which data frame backend is suitable for storing the data in. An operation for adding two columns is a generic operation commonly supported by data frame backends.

When a specific conversion is requested by a numpy.ndarray, the expressions are evaluated and a decision on which data frame backend should be used at each stage of the computational graph is made. In this particular example, the data may be read into a numpy.ndarray to minimize data conversion or, alternatively, into another data frame backend that provides much faster computation to optimize the task graph for speed (rather than conversion-minimization).

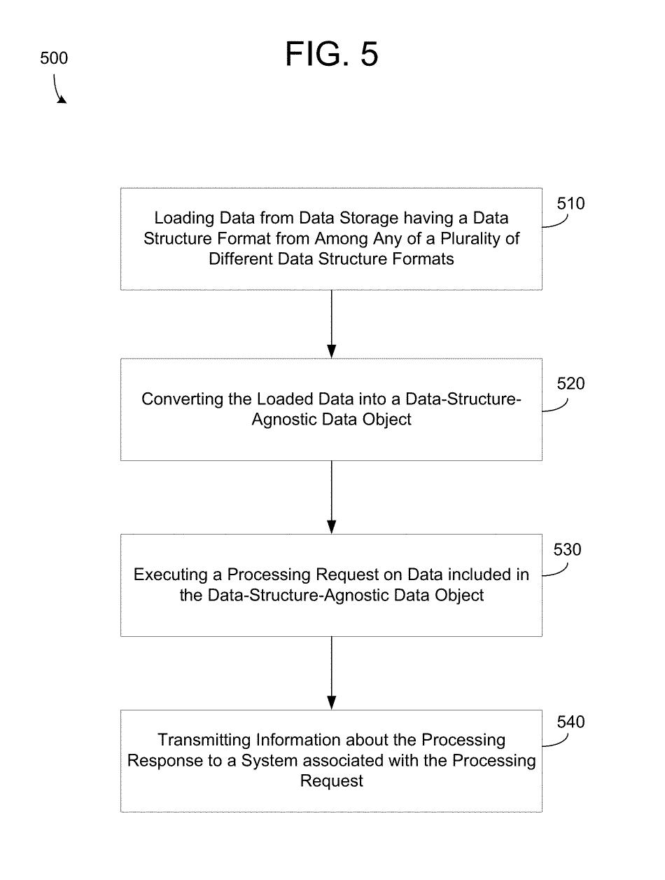

FIG. 5 illustrates a method 500 for deploying a machine learning model in accordance with an example embodiment. For example, the method 500 may be performed by one or more computing system including a web server, a cloud platform, an industrial server, an edge server, a computing device (e.g., desktop, mobile device, appliance, etc.), a database, an on-premises server, and the like. Referring to FIG. 5, in 510 the method includes loading data from a data storage that has a data structure format from among any of a plurality of different data structure formats, and converting the loaded data into a data-structure-agnostic data object. For example, the loading and converting may include pulling columns and/or rows of data from a backend-specific data frame into a backend-agnostic data object. In some embodiments, the loading in 510 and the converting in 520 may be performed simultaneously or they may be performed separately.

For example, the loaded data may include one or more of alert data, time-series data, image data, and the like. The data structure format may include any of a data frame, a data array, a data set, and the like. In some embodiments, the loading and the converting may be implemented by an abstraction API that is configured to ingest data from a plurality of different data backend storage systems corresponding to the plurality of different data structure formats. In this example, each data backend storage system may include a respective backend API, and the abstraction API is configured to transmit processing result information to each of the respective backend APIs of the plurality of different data backend storage systems.

In 530, the method includes executing a processing request on the data-structure-agnostic data object to generate a processing response based on the converted data, and in 540, transmitting information about the generated processing response to a system associated with the processing request. For example, the processing request may be received from a software application or other system requesting interaction and/or manipulation of backend data which has been ingested into the data-structure-agnostic data object. As one non-limiting example, the request may include a request for executing a machine learning model on data included in the data-structure-agnostic data object, and the method may include executing the machine learning model on the data.

In some embodiments, the method may further include receiving the data and selecting a data backend storage system for storing the received data from among a plurality of different data backend storage systems. Here, the API may intelligently select a data backend for storing the incoming data based on a use case of the data, an internal data structure of the backend, and the like.

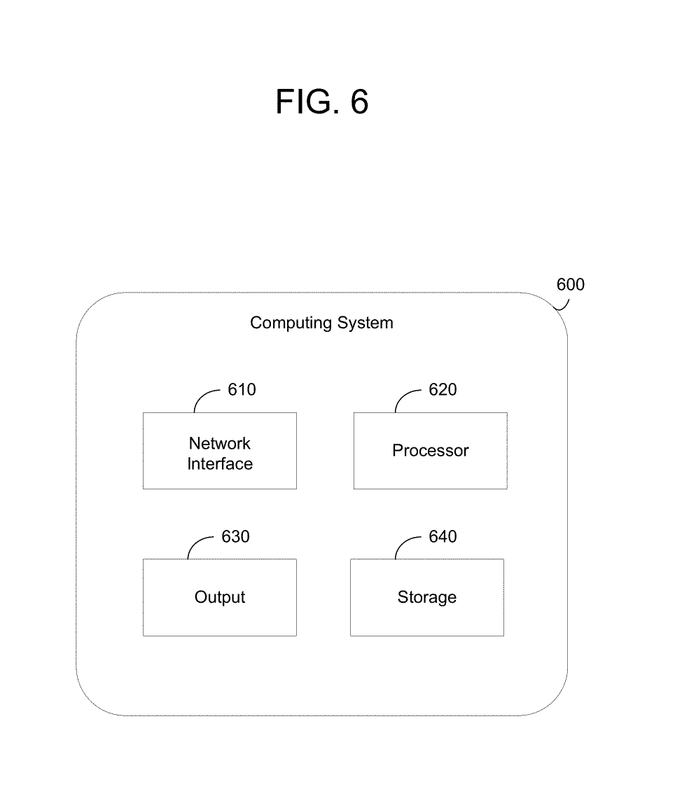

FIG. 6 illustrates a computing system 600 in accordance with an example embodiment. For example, the computing system 600 may be a database, an instance of a cloud platform, a streaming platform, and the like. In some embodiments, the computing system 600 may be distributed across multiple devices. Also, the computing system 600 may perform the method 500 of FIG. 5. Referring to FIG. 6, the computing system 600 includes a network interface 610, a processor 620, an output 630, and a storage device 640 such as a memory. Although not shown in FIG. 6, the computing system 600 may include other components such as a display, one or more input units, a receiver, a transmitter, and the like.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like. The output 630 may include a device such as a port, an interface, or the like, which is controlled by the processor 620. In some examples, the output 630 may be replaced by the processor 620. The storage device 640 is not limited to a particular storage device and may include any known memory device such as RAM, ROM, hard disk, and the like, and may or may not be included within the cloud environment. The storage device 640 may store ML models in a hard disk or long-term storage location and load the ML model from hard disk to RAM, a cache, or the like, during a deploying operation.

According to various aspects, the processor 620 may load data from the memory 640 which has a data structure format from among any of a plurality of different data structure formats, convert the loaded data into a data-structure-agnostic data object, execute a processing request on the data-structure-agnostic data object to generate a processing response based on the converted data, and transmit information about the generated processing response to a system associated with the processing request. For example, the loaded data may include one or more of alert data, time-series data, image data, and the like. The data structure format may include any of a data frame, a data array, a data set, and the like. The data-structure-agnostic data object may abstract away a data structure of an underlying data backend.

In some embodiments, the processor 620 may execute an API that is configured to ingest data from a plurality of different data backend storage systems corresponding to the plurality of different data structure formats. For example, each data backend storage system may include a respective backend API, and the abstraction API may communicate processing result information to each of the respective backend APIs of the plurality of different data backend storage systems. In some embodiments, the processor 620 may receive the data and intelligently select a data backend storage system for storing the received data from among a plurality of different data backend storage systems, for example, based on a use case of the data identified from a workflow, an internal data structure of the backends, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), a random-access memory (RAM) and/or any non-transitory transmitting/receiving medium such as the Internet, cloud storage, the Internet of Things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a memory; and
a processor configured to load data from the memory which has a data structure format from among any of a plurality of different data structure formats, convert the loaded data into a data-structure-agnostic data object, execute a processing request on the data-structure-agnostic data object to generate a processing response based on the converted data, and transmit information about the generated processing response to a system associated with the processing request.

2. The computing system of claim 1, wherein the loaded data comprises one or more of alert data, time-series data, and image data.

3. The computing system of claim 1, wherein the data structure format comprises any of a data frame, a data array, and a data set.

4. The computing system of claim 1, wherein the processor is configured to execute an abstraction application programming interface (API) that is configured to ingest data from a plurality of different data backend storage systems corresponding to the plurality of different data structure formats.

5. The computing system of claim 4, wherein each data backend storage system comprises a respective backend API, and the abstraction API is configured to communicate processing result information to each of the respective backend APIs of the plurality of different data backend storage systems.

6. The computing system of claim 1, wherein the processor is further configured to receive the data and select an optimal data backend storage system for storing the received data from among a plurality of different data backend storage systems based on one or more of a task graph to be generated with the data and a lazy evaluation.

7. The computing system of claim 6, wherein the processor is configured to select the data backend storage system from among the plurality of different data backend storage systems based on a data structure format of the data backend storage system and a data operation associated with the data being stored.

8. The computing system of claim 1, wherein the processing request comprises a request for executing a machine learning model on data included in the data-structure-agnostic data object, and the processor is further configured to execute the machine learning model on the data included in the data-structure-agnostic data object.

9. A computer-implemented method comprising:
loading data from a data storage that has a data structure format from among any of a plurality of different data structure formats;
converting the loaded data into a data-structure-agnostic data object;
executing a processing request on the data-structure-agnostic data object to generate a processing response based on the converted data; and
transmitting information about the generated processing response to a system associated with the processing request.

10. The computer-implemented method of claim 9, wherein the loaded data comprises one or more of alert data, time-series data, and image data.

11. The computer-implemented method of claim 9, wherein the data structure format comprises any of a data frame, a data array, and a data set.

12. The computer-implemented method of claim 9, wherein the loading and the converting is implemented by an abstraction application programming interface (API) that is configured to ingest data from a plurality of different data backend storage systems corresponding to the plurality of different data structure formats.

13. The computer-implemented method of claim 12, wherein each data backend storage system comprises a respective backend API, and the abstraction API is configured to transmit processing result information to each of the respective backend APIs of the plurality of different data backend storage systems.

14. The computer-implemented method of claim 9, further comprising receiving the data and selecting an optimal data backend storage system for storing the received data from among a plurality of different data backend storage systems based on one or more of a task graph to be generated with the data and a lazy evaluation.

15. The computer-implemented method of claim 14, wherein the data backend storage system is selected from among the plurality of different data backend storage systems based on a data structure format of the data backend storage system and a data operation associated with the data being stored.

16. The computer-implemented method of claim 9, wherein the processing request comprises a request for executing a machine learning model on data included in the data-structure-agnostic data object, and the method further comprises executing the machine learning model on the data included in the data-structure-agnostic data object.

17. A non-transitory computer readable medium comprising program instructions which when executed cause a processor to perform a method comprising:
loading data from a data storage that has a data structure format from among any of a plurality of different data structure formats;
converting the loaded data into a data-structure-agnostic data object;
executing a processing request on the data-structure-agnostic data object to generate a processing response based on the converted data; and
transmitting information about the generated processing response to a system associated with the processing request.

18. The non-transitory computer readable medium of claim 17, wherein the loaded data comprises one or more of alert data, time-series data, and image data.

19. The non-transitory computer readable medium of claim 17, wherein the data structure comprises any of a data frame structure, a data array structure, and a data set structure.

20. The non-transitory computer readable medium of claim 17, wherein the loading and the converting is implemented by an abstraction application programming interface (API) that is configured to ingest data from a plurality of different data backend storage systems corresponding to the plurality of different data structure formats.
